(19) United States
(12) Patent Application Publication
(10) Pub. No.: US 2021/0291275 A1
(43) Pub. Date: Sep. 23, 2021

(54) USE OF POWDERS OF HIGHLY REFLECTIVE METALS FOR ADDITIVE MANUFACTURE

(71) Applicant: HERAEUS ADDITIVE MANUFACTURING GMBH, Hanau (DE)

(72) Inventors: Moritz Stolpe, Hanau (DE); Jakob Fischer, Hanau (DE); Tim Protzmann, Hanau (DE); Michael Klosch-Trageser, Hanau (DE)

(21) Appl. No.: 17/259,901

(22) PCT Filed: Jul. 17, 2019
(86) PCT No.: PCT/EP2019/069250

§ 371 Date: Jan. 12, 2021

(30) Foreign Application Priority Data
Jul. 19, 2018 (EP) 18184340.0

(51) Int. Cl. B22F 10/28; B22F 9/08

(52) U.S. Cl. CPC B22F 10/28; B22F 9/08; B22F 2301/10; B22F 2301/40; B22F 2301/255; B22F 2301/052

(57) ABSTRACT

The present invention relates to the use of a metal powder for additively manufacturing a shaped metal body by means of laser beam melting, wherein the metal is a metal of Group 11 of the periodic table of the elements or aluminium or an alloy or intermetallic phase of one of these metals and has an oxygen content of at least 2500 ppm by weight.

The present invention relates to the use of powders of highly reflective metals (such as for example copper, gold, silver or aluminium) for additive manufacturing by means of laser beam melting.

Additive manufacturing methods operate without a tool and without a mould. The volume of an object is in this case built up in layers according to a digital computer model.

Shaped metal bodies can also be produced via additive manufacturing. By way of example, the additive manufacturing is performed via beam melting of a metal powder (powder bed-based method). Laser or electron beams are used as beam sources (selective laser beam melting, selective electron beam melting).

In selective laser beam melting, the material to be processed is applied in powder form in a thin layer onto the build platform or onto a material layer already deposited previously. The powdery material is partially or completely melted in pre-defined areas of the powder layer by means of laser radiation and after solidification forms a solid material layer. Subsequently, the base plate is lowered by the amount of one layer thickness and powder is applied again. This cycle is repeated until the finished shaped body is obtained. In selective electron beam melting, the local melting of the powder is effected by an electron beam.

The current state of additive manufacturing of shaped metal bodies, for example by laser beam and electron beam melting of metal powder applied in layers, is described by way of example by D. Herzog et al., Acta Materialia, 117 (2016), pp. 371-392.

Metals having high electrical conductivity, especially copper, gold, silver and aluminium, are materials of interest. On account of their strong reflection in the infrared wavelength region, processing these materials by means of a laser beam represents a great challenge, since most continuously radiating high-power lasers (CW lasers) currently available operate precisely in this wavelength region. This problem is described by way of example by M. Naeem, Laser Technik Journal, Volume 10, January 2013, pp. 18-20, and in US 2015/102016 A1. In order to improve absorption of the laser radiation by strongly reflecting metals, lasers can be used that have a lower wavelength (e.g. “green” lasers). These lasers, however, currently do not have sufficient power and stability.

If a material exhibits low absorption behaviour in the wavelength region of the exciting radiation (for example due to high reflectivity), only a small amount of energy can be coupled into the material and as a result melting of the material is hindered or even prevented. This can lead to an unstable melt bath. In order to realize relevant component properties (such as density, electrical and thermal conductivity, strength, surface quality), forming a stable melt bath is, however, of particular importance.

In addition to the optical properties (absorption, reflection), the thermal properties of the material also influence the formation of the melt bath. By way of example, the thermal conductivity determines how quickly the locally coupled-in heat is distributed to the surroundings. Materials having high thermal conductivities therefore hinder additive manufacturing.

EP 3 093 086 A1 describes the use of a copper powder containing silicon and/or chromium as alloying elements for additive manufacturing by means of laser beam melting. The oxygen content of the copper powder is less than 1000 ppm by weight.

DE 10 2017 102 355 A1 describes the production of a shaped article from a metal powder by an additive manufacturing method, where the powder is modified by suitable measures so that the absorption of the laser beam is increased. The metal powder might be introduced into the build chamber in the form of a powder layer and this powder layer is surface oxidized. In order to ensure sufficient oxidation of the powder layer, the gas atmosphere in the build chamber contains still sufficient atmospheric oxygen. The oxygen content of the surface-oxidized metal powder is not specified.

US 2018/051376 A1 describes the production of a shaped article from a metal powder by an additive manufacturing method, where the powder particles introduced into the build chamber are provided with a coating composed of a “sacrificial material”. The sacrificial material is for example an oxide. The metal particles and the sacrificial material are provided separately and the sacrificial material is subsequently applied to the powder particles by suitable coating methods such as, for example, CVD or PVD.

P. Frigola et al., “Fabricating Copper Components with Electron Beam Melting”, Advanced Materials & Processes, July 2014, pp. 20-24, describe the production of Cu shaped bodies by means of electron beam melting. However, for electron beam melting of copper, the problem of high reflectivity is not an issue.

R. Guschlbauer et al., “Herausforderungen bei der Additiven Fertigung von Reinkupfer mit dem selektivem Elektronenstrahlschmelzen” [Challenges in the Additive Manufacturing of Pure Copper using Selective Electron Beam Melting], Metal, 11/2017, pp. 459-462, also describe the production of shaped copper bodies by means of electron beam melting.

It is an object of the present invention to provide an additive manufacturing method by means of laser beam melting which is suitable for metals having low laser beam absorption and enables the production of high-density metal bodies even when using lasers that operate in the infrared wavelength region.

The shaped metal body obtained via the additive manufacturing method should preferably have properties (such as electrical or thermal conductivity) which are as similar as possible to those of shaped bodies being produced by conventional methods such as casting.

The object is achieved by a method for additively manufacturing a shaped metal body by means of laser beam melting, comprising
(i) applying a metal powder in the form of a layer onto a substrate in a build chamber, wherein the metal
   is a metal of Group 11 of the periodic table of the elements or aluminium or an alloy or intermetallic phase of one of these metals and
   has an oxygen content of at least 2500 ppm by weight;
(ii) selectively melting the metal powder in the layer by means of a laser beam and allowing the molten metal to solidify,
(iii) applying a further layer of the metal powder onto the previously applied layer,
(iv) selectively melting the metal powder in the further layer by means of the laser beam and allowing the molten metal to solidify;
(v) repeating steps (iii)-(iv) until the shaped metal body has been completed.

The metals of Group 11 of the periodic table of the elements, such as copper, silver or gold, and also the metal aluminium have the common feature of having an absorption of less than 20% in the NIR region, especially in the wavelength region of 800-1250 nm (and thus in the wavelength region of most of the continuously radiating high-power lasers currently available).

The use of a powder of these metals, the oxygen content of which is at least 2500 ppm by weight, allows a stable melt bath to be produced in the laser treatment. This leads in turn to the formation of a metal of high density after solidification.

The metal of Group 11 of the periodic table of the elements is preferably copper, silver or gold or an alloy or intermetallic phase of one of these metals.

The term “alloy of a metal” is understood to mean an alloy that contains this metal as main component (for example in a proportion of more than 50 at %, more preferably more than 65 at % or even more than 75 at %) and additionally one or more alloying elements. The alloy can further contain, for example, two or more of the abovementioned metals (for example at least two metals of Group 11 of the periodic table or at least one metal of Group 11 of the periodic table and aluminium) in a total amount of at least 65 at %, more preferably at least 75 at % or even at least 85 at %.

The oxygen content of the metal is determined in a reduction-extraction process according to DIN EN ISO 4491-4:2013-08.

The metal powder preferably has an oxygen content of at least 3500 ppm by weight, more preferably at least 5000 ppm by weight.

In one preferred embodiment, the metal powder has an oxygen content in the range of 2500-15 000 ppm by weight, more preferably 3500-10 000 ppm by weight, more preferably still 5000-10 000 ppm by weight, most preferably 5500-10 000 ppm by weight.

As will be described in more detail below, it may be preferable to subject the metal, solidified after one of the laser melting steps, or the shaped metal body to a thermal treatment under reduced pressure or in a reducing gas atmosphere. The oxygen can be at least partially removed from the metal by this thermal treatment, which can have advantageous effects on certain properties such as thermal or electrical conductivity. The time period required for the thermal treatment can be reduced if the oxygen content is at most 15 000 ppm by weight, more preferably at most 10 000 ppm by weight.

In one exemplary embodiment, the metal consists of copper, oxygen in one of the amounts specified above and optionally one or more further constituents that, if present, are present in a total amount of at most 1% by weight, more preferably at most 0.5% by weight, more preferably still at most 0.04% by weight.

A metal powder containing oxygen in the amounts specified above can be produced by methods known to those skilled in the art. The metal powder is preferably produced via atomization in an oxygen-containing atmosphere. Suitable process conditions by way of which the oxygen content of the powder can be adjusted are known to those skilled in the art or can be ascertained if need be by routine experiments. In atomization, molten metal is divided into small droplets and these solidify rapidly before they come into contact with one another or with a solid surface. The principle of the method is based on the division of a thin, liquid metal jet by a gas stream that impinges at high speed. As is known to those skilled in the art, the particle size can be adjusted within a broad range by varying process parameters such as shape and arrangement of the nozzles, pressure and mass flow of the atomization medium or thickness of the liquid metal jet.

Suitable particle sizes of a metal powder within the context of an additive manufacturing method are known to those skilled in the art or can be determined if need be by routine experiments. By way of example, the metal powder has a cumulative volume distribution curve having particle sizes in the range of 1-100 μm. In one exemplary embodiment, the metal powder has a cumulative volume distribution curve having a d₁₀ value of at least 2 μm and a d₉₀ value of at most 90 μm.

The particle size distribution on the basis of a cumulative volume distribution curve is determined by means of laser diffraction. The powder is measured as a dry dispersion by means of laser diffraction particle size analysis according to ISO 13320:2009 and the cumulative volume distribution curve is determined from the measured data. The d₁₀ and d₉₀ values can be calculated from the cumulative volume distribution curve according to ISO 9276-2:2014. Here, for example, “d₁₀” means that 10% by volume of the particles have a diameter below this value.

Applying the metal powder in the form of a layer onto a substrate in a build chamber of an apparatus for laser beam melting is effected under conditions known to those skilled in the art.

The substrate may be the as-yet uncoated build platform in the build chamber of the apparatus or alternatively may be material layers, already previously deposited on the build platform, of the shaped body to be produced. Alternatively, an already pre-fabricated insert composed of this or another material could also be used. The layer-wise application of the metal powder is effected by way of example by a doctor blade, a roller, a press or by screen printing or a combination of at least two of these methods. After applying the powder, step (ii) can be effected, for example, without any further intermediate steps.

There is preferably an inert or reductive gas atmosphere in the build chamber.

The selective melting of the pulverulent metal by means of at least one laser beam is effected in step (ii). As is known, the term “selective” expresses the fact that, in the context of the additive manufacturing of a shaped body, melting of the metal powder takes place only in defined, predetermined regions of the layer on the basis of digital 3D data of the shaped body.

Lasers that can be used for the additive manufacturing by means of laser beam melting are known to those skilled in the art. The use of the above-described metal powder can allow advantageous melting behaviour to be realized even with a laser beam having a wavelength in the IR region. In one preferred embodiment, therefore, an IR laser, that is to say a laser beam having a wavelength in the infrared region (e.g. 750 nm to 30 μm), is used for the additive manufacturing of the shaped metal body. As an alternative, however, within the scope of the present invention, laser beams having a lower wavelength, for example in the region of visible light (e.g. 400-700 nm), may also be used.

After solidification of the molten metal, step (iii) can be effected, for example, without any further intermediate steps. Alternatively, for example, after step (ii) and before step (iii), the solidified metal can be subjected to a thermal treatment. This thermal treatment is preferably conducted under reduced pressure (e.g. at 10⁻³ to 10⁻⁴ mbar, more preferably 10⁻⁴ to 10⁻⁵ mbar) or in a reducing gas atmosphere (e.g. a gas atmosphere containing hydrogen or a forming gas). The thermal treatment is conducted, for example, at a temperature in the range of 0.1×Tₘ to 0.99×Tₘ, where Tₘ is the melting temperature of the metal. By way of example, the thermal treatment can be conducted at a relatively moderate temperature in the range of 0.1×Tₘ to 0.6×Tₘ. However, it is also possible to conduct the temperature treatment at a higher temperature in the range of 0.6×Tₘ to 0.99×Tₘ. If the metal is copper, the thermal treatment of the solidified metal is conducted, for example, at a temperature in the range of 110° C. to 980° C. For example, the thermal treatment of the solidified copper can be conducted at a temperature in the range of 110° C. to 650° C., more preferably 150° C. to 400° C. However, it is also possible for the temperature treatment of the solidified copper to be conducted at a higher temperature in the range of 650° C. to 980° C., more preferably 700° C. to 900° C. The thermal treatment of the solidified metal under reduced pressure or in a reducing atmosphere can have advantageous effects on certain properties such as thermal or electrical conductivity.

Between step (ii) and step (iii), the build platform is preferably lowered by an amount that substantially corresponds to the layer thickness of the applied powder layer. This procedure within the scope of the additive manufacturing of a shaped body is generally known to those skilled in the art.

Application of a further layer of the metal powder in step (iii) can be effected in the same manner as in step (i). Step (iv) can also be conducted in the same manner as step (ii). Optionally, after step (iv), a thermal treatment may be conducted again under the conditions already described above.

The above-described method steps are repeated until the shaped metal body has been completed.

After its completion, the shaped metal body is preferably subjected to a thermal treatment. As already described above, this thermal treatment is preferably conducted under reduced pressure (e.g. at 10⁻³ to 10⁻⁶ mbar, more preferably 10⁴ to 10⁻⁵ mbar) or in a reducing gas atmosphere (e.g. a gas atmosphere containing hydrogen or a forming gas). The thermal treatment is conducted, for example, at a temperature in the range of 0.1×Tₘ to 0.99×Tₘ, where Tₘ is the melting temperature of the metal. By way of example, the thermal treatment can be conducted at a relatively moderate temperature in the range of 0.1×Tₘ to 0.6×Tₘ. However, it is also possible to conduct the temperature treatment at a higher temperature in the range of 0.6×Tₘ to 0.99×Tₘ. If the metal is copper, the thermal treatment of the shaped body is conducted, for example, at a temperature in the range of 110° C. to 980° C. For example, the thermal treatment of the shaped body can be conducted at a temperature in the range of 110° C. to 650° C., more preferably 150° C. to 400° C. However, it is also possible for the temperature treatment of the shaped body to be conducted at a higher temperature in the range of 650° C. to 980° C., more preferably 700° C. to 900° C. The duration of the thermal treatment is, for example, 1-180 hours, more preferably 5-40 hours. The thermal treatment of the shaped body under reduced pressure or in a reducing atmosphere can have advantageous effects on certain properties such as thermal or electrical conductivity.

The present invention further provides for the use of the above-described metal powder for additive manufacturing by means of laser beam melting. Reference can be made to the statements above with respect to the preferred properties of the metal powder.

The invention is explained in more detail by way of the following examples.

### EXAMPLES

In the following examples and comparative examples, the following laser was used for the selective laser melting: Yb fibre laser, 1060-1100 nm.

### Example 1

In Example 1, a copper powder having an oxygen content of 7300 ppm by weight was used. The powder had a volume-based particle size distribution having a d₁₀ value of 20 μm and a d₉₀ value of 52 μm.

The copper powder was applied to the build platform in the build chamber of the apparatus in the form of a thin layer (layer thickness of approximately 20 μm). Melting of the metal powder in defined regions of the applied layer was effected at room temperature. Argon was used as gas atmosphere in the build chamber. The laser melting step was subsequently started. The laser beam moved at a speed of 500 mm/s, with a beam power of 370 W and a spacing between adjacent lines of 70 μm, over a predefined area of 10×10 mm² of the applied layer.

A stable melt bath formed with the copper powder used in Example 1.

Micrographs were produced of the area covered by the laser beam. The micrographs show a high-density structure. Porosity was only 0.3%.

The electrical conductivity (% IACS) of the shaped body before and after annealing (10 h at 800° C. under reduced pressure) was determined:

Before: 64%

After: 84%

Electrical conductivity was determined by the four-point method.

### Example 2

In Example 2, a copper powder having an oxygen content of 5740 ppm by weight was used. The powder had a volume-based particle size distribution having a d₁₀ value of 16 μm and a d₉₀ value of 53 μm.

The experimental parameters were identical to those in Example 1.

A stable melt bath formed with the copper powder used in Example 2.

Micrographs were produced of the area covered by the laser beam. The micrographs show a high-density structure. Porosity was only 0.2%.

The electrical conductivity (% IACS) of the shaped body before and after annealing (15 h at 600° C. under reduced pressure) was determined:

Before: 66%

After: 82%

Electrical conductivity was determined by the four-point method.

### Comparative Example 1

In Comparative Example 1, a copper powder having an oxygen content of 318 ppm by weight was used. The powder had a volume-based particle size distribution having a d₁₀ value of 20 μm and a d₉₀ value of 56 μm.

The copper powder was applied to a build platform under the same conditions as in Example 1 and subjected to laser beam treatment.

A stable melt bath could not be formed with the copper powder used in Comparative Example 1 and accordingly a mechanically stable high-density component could not be obtained.

Micrographs were produced of the area covered by the laser beam. The micrographs show a defect-rich structure. Porosity was >5%.

### Comparative Example 2

In Comparative Example 2, a copper powder having an oxygen content of 2219 ppm by weight was used. The powder had a volume-based particle size distribution having a d₁₀ value of 15 μm and a d₉₀ value of 41 μm.

The copper powder was applied to a build platform under the same conditions as in Example 1 and subjected to laser beam treatment.

A stable melt bath could not be formed with the copper powder used in Comparative Example 2 and accordingly a mechanically stable high-density component could not be obtained.

Micrographs were produced of the area covered by the laser beam. The micrographs show a defect-rich structure. Porosity was 4.4%.

The results of the examples described above are summarized in Table 1 below.

TABLE 1
Stability of the melt bath and porosity of the solidified metal

| | Example 1 | Example 2 | Comp. Ex. 1 | Comp. Ex. 2 |
|---|---|---|---|---|
| Oxygen content | 7300 ppm | 5740 ppm | 318 ppm | 2219 ppm |
| of the powder | by weight | by weight | by weight | by weight |
| Stable melt bath | Yes | Yes | No | No |
| Porosity of the | 0.3% | 0.2% | >5% | 4.4% |
| solidified metal | | | | |

1. Method for additively manufacturing a shaped metal body by means of laser beam melting, comprising
(i) applying a metal powder in the form of a layer onto a substrate in a build chamber, wherein the metal
is a metal of Group 11 of the periodic table of the elements or aluminium or an alloy or intermetallic phase of said metal and
has an oxygen content of at least 2500 ppm by weight;
(ii) selectively melting the metal powder in the layer by means of at least one laser beam and allowing the molten metal to solidify,
(iii) applying a further layer of the metal powder onto the previously applied layer,
(iv) selectively melting the metal powder in the further layer by means of the laser beam and allowing the molten metal to solidify;
(v) repeating steps (iii)-(iv) until the shaped metal body has been completed.

2. Method according to claim 1, wherein the metal is copper, silver or gold or an alloy or intermetallic phase of one of these metals.

3. Method according to claim 1 or 2, wherein the oxygen content of the metal powder is 2500-15 000 ppm by weight, more preferably 3500-10 000 ppm by weight, more preferably still 5000-10 000 ppm by weight, most preferably 5500-10 000 ppm by weight.

4. Method according to any of the preceding claims, wherein the metal powder is produced via atomization in an oxygen-containing atmosphere.

5. Method according to any of the preceding claims, wherein the metal powder has particle sizes in the range of 1 to 100 μm.

6. Method according to any of the preceding claims, wherein the build chamber contains an inert or reducing gas atmosphere.

7. Method according to any of the preceding claims, wherein, after solidification of the molten metal and before application of a further layer, the solidified metal is subjected to a thermal treatment under reduced pressure or in a reducing gas atmosphere; and/or the shaped metal body is subjected to a thermal treatment under reduced pressure or in a reducing gas atmosphere after its completion.

8. Use of the metal powder according to any of claims 1-5 for additive manufacturing by means of laser beam melting.
